(19) United States
(12) Patent Application Publication
(10) Pub. No.: US 2019/0129184 A1
(43) Pub. Date: May 2, 2019

(54) Laser-based display engine in wearable display devices

(71) Applicant: Snail Innovation Institute, San Jose, CA (US)

(72) Inventors: Darwin Hu, San Jose, CA (US); Leo Chen, Diamond Bar, CA (US); Jangho Choi, Kyeonggi-do (KR)

(21) Appl. No.: 16/231,550

(22) Filed: Dec. 23, 2018

Related U.S. Application Data
(63) Continuation-in-part of application No. 15/996,499, filed on Jun. 3, 2018.
Application No. 15/996,499 is a continuation-in-part of application No. 15/944,691, filed on Apr. 3, 2018.
Application No. 15/944,691 is a continuation of application No. 15/372,957, filed on Dec. 8, 2016, now Pat. No. 9,946,075.

(51) Int. Cl. G02B 27/01; G02B 6/44; F21V 8/00; G06F 1/16; G06F 3/01; G02B 27/00; G02B 6/42

(52) U.S. Cl. CPC G02B 27/0172; G02B 6/443; G02B 6/4471; G02B 6/003; G02B 6/0035; G06F 1/163; G02B 3/14; G02B 6/0006; G02B 6/0008; G02B 27/0093; G02B 6/4204; G06F 3/011; G06F 3/013

(57) ABSTRACT

Designs of a laser-based display engine for wearable display devices are described. A laser source is provided to produce a laser dot in one of three primary colors. The laser dot is projected upon a lens before it hits an optical unit, wherein the optical unit then produces a laser plane from the laser dot. An optical cube, formed by two triangular prisms, includes a transmissive reflector disposed between two sloping rectangular sides of the triangular prisms. A collimation lens is provided to collimate the laser plane and project the collimated laser plane into the optical cube, where the collimated laser plane is reflected by the transmissive reflector to a microdisplay. The reflected laser beams from the microdisplay transmit through the transmissive reflector and eventually are projected in a waveguide. Depending on the implementation, the optical unit may include a collimation lens or a micro lens array (MLA).

### BACKGROUND OF THE INVENTION

### Field of the Invention

The present invention generally is related to the area of display devices and more particularly related to integrated lenses, frames and light sources used in the display devices, where the integrated lenses, frames and light sources are amenable to smaller footprint, enhanced impact performance, lower cost packaging, and easier manufacturing process. To make the wearable display devices more appearing to users, the present invention is also related to various exterior designs of the frames.

### Description of the Related Art

Virtual Reality or VR is generally defined as a realistic and immersive simulation of a three-dimensional environment created using interactive software and hardware, and experienced or controlled by movement of the body. A person using virtual reality equipment is typically able to look around the artificially generated three-dimensional environment, moves around in it and interacts with features or items that are depicted on a screen or in goggles. Virtual realities artificially create sensory experiences, which can include sight, touch, hearing, and, less commonly, smell.

Augmented reality (AR) is a technology that layers computer-generated enhancements atop an existing reality in order to make it more meaningful through the ability to interact with it. AR is developed into apps and used on mobile devices to blend digital components into the real world in such a way that they enhance one another, but can also be told apart easily. AR technology is quickly coming into the mainstream. It is used to display score overlays on telecasted sports games and pop out 3D emails, photos or text messages on mobile devices. Leaders of the tech industry are also using AR to do amazing and revolutionary things with holograms and motion activated commands.

The delivery methods of Virtual Reality and Augmented Reality are different when viewed separately. Most 2016-era virtual realities are displayed either on a computer monitor, a projector screen, or with a virtual reality headset (also called head-mounted display or HMD). HMDs typically take the form of head-mounted goggles with a screen in front of the eyes. Virtual Reality actually brings the user into the digital world by cutting off outside stimuli. In this way user is solely focusing on the digital content being displayed in the HMDs. Augmented reality is being used more and more in mobile devices such as laptops, smart phones, and tablets to change how the real world and digital images, graphics intersect and interact.

In reality, it is not always VR vs. AR as they do not always operate independently of one another, and in fact are often blended together to generate an even more immersing experience. For example, haptic feedback, which is the vibration and sensation added to interaction with graphics, is considered an augmentation. However, it is commonly used within a virtual reality setting in order to make the experience more lifelike though touch.

Virtual reality and augmented reality are great examples of experiences and interactions fueled by the desire to become immersed in a simulated land for entertainment and play, or to add a new dimension of interaction between digital devices and the real world. Alone or blended together, they are undoubtedly opening up worlds, both real and virtual alike.

FIG. 1A shows an exemplary goggle now commonly seen in the market for the application of delivering or displaying VR or AR. No matter how a goggle is designed, it appears bulky and heavy, and causes inconvenience when worn on a user. Further most of the goggles cannot be seen through. In other words, when a user wears a goggle, he or she would not be able to see or do anything else. Thus, there is a need for an apparatus that can display the VR and AR but also allows a user to perform other tasks if needed.

Various wearable devices for VR/AR and holographic applications are being developed. FIG. 1B shows a sketch of HoloLens from Microsoft. It weights 579 g (1.2 lbs). With the weight, a wearer won't feel comfortable when wearing it for a period. Indeed, what is available in the market is generally heavy and bulky in comparison to normal glasses. Thus there is still another need for a wearable AR/VR viewing or display device that looks similar to a pair of regular glasses but is also amenable to smaller footprint, enhanced impact performance, lower cost packaging, and easier manufacturing process.

Regardless how a wearable display device is designed, many glasses-like display devices employ a boring design that does not look like a pair of regular reading glasses. There is thus still another need to make such glasses more fashionable or at least hi-tech look.

There are many components, wires and even batteries that must be used to make the display device function and operable. While there have been great efforts to move as many parts as possible to an attachable device or enclosure to drive the display device from a user's waist or pocket, the essential parts, such as copper wires, must be used to transmit various control signals and image data. The wires, often in form of a cable, do have a weight, which adds a pressure on a wearer when wearing such a display device. There is yet another need for a transmission medium that can be as light as possible without sacrificing the needed functions.

There are many other needs that are not to be listed individually but can be readily appreciated by those skilled in the art that these needs are clearly met by one or more embodiments of the present invention detailed herein.

### SUMMARY OF THE INVENTION

This section is for the purpose of summarizing some aspects of the present invention and to briefly introduce some preferred embodiments. Simplifications or omissions in this section as well as in the abstract and the title may be made to avoid obscuring the purpose of this section, the abstract and the title. Such simplifications or omissions are not intended to limit the scope of the present invention.

The present invention is generally related to architecture and designs of wearable devices that may be for virtual reality and augmented reality applications. According to one aspect of the present invention, a display device is made in form of a pair of glasses and includes a minimum number of parts to reduce the complexity and weight thereof. According to one aspect of the present invention, a wearable device includes a pair of integrated lenses, a lens frame accommodating the integrated lenses and two temples coupled respectively to two opposite ends of the lens frame. The integrated lens includes a transparent optical waveguide and two couplers. Each of the temples includes a conduit to accommodate a cable received at one end thereof and an enclosure on an inner side thereof, wherein the enclosure includes electronic parts powered by wires in the cable and optical parts receiving optical signals from at least two optical fibers in the cable. Depending on an implementation, the temples and/or the lens frame glows when one of the optical fibers is coupled to a light source being turned on.

According to another aspect of the present invention, at least one integrated lens is used the glasses. The integrated lens includes at least a lens, a protecting sheet, an optical waveguide integrated with the lens, and a clear sheet, where the optical waveguide is coupled to two couplers disposed on two ends of the waveguide. The waveguide is smaller than the lens in size. The clear sheet is provided to supplement the waveguide to match the lens in size. The optical waveguide is sandwiched between the lens and the protecting sheet.

According to still another aspect of the present invention, the waveguide is largely surrounded by a medium whose refraction index is significantly less than that of the waveguide to ensure the proper propagation of an optical image within the waveguide by total internal reflections. Depending on an implementation, the medium may be air, a type of gas or a solid but transparent material (e.g., polycarbonate).

According to still another aspect of the present invention, the waveguide is provided to propagate an optical image being projected into one end of the waveguide to another end along an optical path so that a user can see an image formed per the optical image.

According to still another aspect of the present invention, the waveguide together with two couplers is sandwiched by a clear sheet and a prescription lens. Depending on implementation, the sheet is provided to protect one side of the waveguide or may be tinted (e.g., to block glares). The prescription lens is provided to protect the other side of the waveguide and help those impaired with their vision.

According to still another aspect of the present invention, certain edges of the wearable display device or glasses are illuminated by embedding one or more optical fibers around the edges. The optical fibers are extended beyond the glasses and coupled to a light source. Depending on the location or disposition of the optical fibers, a wearer with such display glasses may get attention from others and show off certain fashions. Various designs on the light source to achieve different glowing colors are implemented.

According to still another aspect of the present invention, a single cable is used to transport an electronic image to a micro display or microdisplay that may be disposed near or on the bridge. The cable may go through either one of the temples of the glasses. A splitting mechanism disposed near or right on the bridge of the glasses is used to split an optical image into two versions, one for the left integrated lens and the other for the right integrated lens. These two optical images are then respectively projected into the prisms or waveguides that may be used in the two lenses.

To further reduce the weight of the display device, according to still another aspect of the present invention, an active optical cable is used as a communication medium between a pendant and a portable device, where the portable device is wearable by or attachable to a user. The active optical cable includes two ends and at least one optical fiber and two wires, where the two ends are coupled by the optical fiber and two wires. The two wires carry power and ground to energize the two ends and the operation of the display device while the at least optical fiber is used to carry all data, control and instruction signals.

According to still another aspect of the present invention, when the active optical cable reaches the pendant, the active optical cable includes or activates another optical fiber that is illuminate by a light source enclosed in the pendant. The another optical fiber is used to make the temples or the lens frame glow in different or same colors independent from or in synch with a media being displayed in the integrated lenses or the display glasses.

According to still another aspect of the present invention, a laser source is provided to produce a laser dot in one of three primary colors. The laser dot is converted to a laser plane via an optical unit. The laser plane is used to shine a microdisplay and modulated by the displayed media. The reflected laser beams from the microdisplay are eventually projected into the waveguide. Depending on the implementation, the optical unit may include a collimation lens or a micro lens array (MLA).

According to yet another aspect of the present invention, the portable device may be implemented as a standalone device or a docking unit to receive a smartphone. The portable device is primarily a control box that is connected to a network (e.g., the Internet) and generates control and instruction signals when controlled by a user. When a smartphone is received in the docking unit, many functions provided in the smartphone may be used, such as the network interface and touch screen to receive inputs from the user.

The present invention may be implemented as an apparatus, a method, and a part of system. Different implementations may yield different benefits, objects and advantages. In one embodiment, the present invention is an integrated lens comprising: at least a lens, a protecting optical sheet, an optical waveguide integrated with the lens, and a clear sheet provided to supplement the waveguide to match the lens in size. The optical waveguide, sandwiched between the lens and the protecting sheet, includes a first coupler and a second coupler. Both of the couplers are disposed respectively on two opposing ends of the waveguide, where the first coupler is provided to couple an optical image into the waveguide and the second coupler is provided to couple the optical image out after the optical image has been propagated through the waveguide.

In another embodiment, the present invention is a display device comprising: at least an integrated lens, a lens frame to accommodate the integrated lens, and two temples coupled respectively to two opposite ends of the lens frame. Each of the temples includes a conduit to accommodate a cable received at one end thereof and an enclosure on an inner side thereof. The enclosure includes electronic parts powered by wires in the cable and optical parts receiving optical signals from at least one optical fiber in the cable. The cable further includes a specific optical fiber, where the specific optical fiber is parted away from the cable when the cable reaches one end of a temple, and embedded in top and bottom sides of the temple. The temple glows when a light is turned on and one end of the specific optical fiber is coupled to the light source.

In still another embodiment, the present invention is a display device comprising: at least an integrated lens, a lens frame to accommodate the integrated lens, and two temples coupled respectively to two opposite ends of the lens frame. The lens frame includes a number of frames including a structure frame, a rear frame, and a middle frame integrated between the structure frame and the rear frame. Depending on implementation, both of the structure frame and the rear frame are opaque. The middle frame is made out of a type of non-opaque material. An optical fiber is disposed around an outer side of the middle frame. The lens frame glows when the optical fiber is coupled to a light source being turned on.

In still another embodiment, the present invention is a display engine comprising: a laser source producing a laser dot in one of three primary colors, a lens impinged upon with the laser dot, an optical unit producing a laser plane from the laser dot, an optical cube formed by two triangular prisms and including a transmissive reflector disposed between two sloping rectangular sides of the triangular prisms, and a collimation lens provided to collimate the laser plane and project the collimated laser plane into the optical cube. The collimated laser plane is reflected by the transmissive reflector to a microdisplay. Reflected laser beams transmit through the transmissive reflector and eventually are projected in a waveguide.

In yet another embodiment, the present invention is a method for a display engine to operate for media display in a wearable display device. The method comprises: receiving a laser dot in one of three primary colors, impinging the laser dot upon a lens, converting the laser dot laser into a laser plane via an optical unit, projecting the laser plane onto an optical cube formed by two triangular prisms and including a transmissive reflector disposed between two sloping rectangular sides of the triangular prisms, collimating the laser plane via a collimation lens; and projecting the collimated laser plane into the optical cube, where the collimated laser plane is reflected by the transmissive reflector to a microdisplay, reflected laser beams transmit through the transmissive reflector and eventually are projected in a waveguide.

There are many other objects, together with the foregoing attained in the exercise of the invention in the following description and resulting in the embodiment illustrated in the accompanying drawings.

### BRIEF DESCRIPTION OF THE DRAWINGS

These and other features, aspects, and advantages of the present invention will become better understood with regard to the following description, appended claims, and accompanying drawings where:

FIG. 1A shows an exemplary goggle now commonly seen in the market for the application of delivering or displaying VR or AR;

FIG. 1B shows a sketch of HoloLens from Microsoft;

FIG. 2A shows a pair of exemplary glasses 200 that are used for applications of VR/AR according to one embodiment of the present invention;

FIG. 2B shows that the optical fibers are embedded in the surrounding edges of the lens frame of the glasses shown in FIG. 2A;

FIG. 2C shows two exemplary configurations A and B in which a sample structure of the light source may be used to illuminate the optical fibers used in FIG. 2B;

FIG. 2D shows an exemplary structure of the lens frame in the glasses according to one embodiment of the present invention;

FIG. 2E shows a perspective view of an exemplary display glasses according to one embodiment of the present invention;

FIG. 2F shows a rear perspective of an exemplary display glasses according to one embodiment of the present invention and a corresponding exposed internal structure of the temple shown in FIG. 2D;

FIG. 2G shows an implementation of a light source including a light guide, a shade and two lights;

FIG. 2H shows a laser-based assembly that fits into an enclosure according to another embodiment of the present invention;

FIG. 2I shows an overview of FIG. 2H but uses a different laser source according to one embodiment of the present invention;

FIG. 2J shows one exemplary embodiment of generating a 2D laser plane from a laser dot using a set of optical parts;

FIG. 2K shows another embodiment of using a laser plane;

FIG. 2L shows a cross section of one implementation according to the embodiment shown in FIG. 2K;

FIG. 2M shows a shirt in which a cable is enclosed within the shirt or attached thereto;

FIG. 3A shows that an optical waveguide is used to transport an optical image from one end to another end thereof;

FIG. 3B shows an implementation of an optical waveguide including first and second optical couplers provided to couple an optical image into the waveguide and couple the optical image out after the optical image has propagated through the optical waveguide;

FIG. 4A shows an embodiment of an integrated lens used in the display glasses according to one embodiment of the present invention;

FIG. 4B shows another embodiment of an integrated lens in which an amplifying lens is integrated in with the waveguide so that a displayed image in the waveguide is amplified when seeing through the integrated lens;

FIG. 4C shows an implementation of an integrated lens in which a waveguide is encapsulated in a lens filled with air;

FIG. 4D shows another implementation of an integrated lens in which the refractive index of the waveguide and the couplers substantially higher than that of a prescription lens and/or a protecting sheet or lens;

FIG. 4E and FIG. 4F show a front perspective of an exemplary display glasses per one embodiment and a corresponding rear perspective of the display glasses;

FIG. 5 shows an exemplary functional block diagram that may be used in a portable device or enclosure to produce content related to virtual reality and augmented reality for display on the exemplary glasses of FIG. 2A;

FIG. 6A shows a modified version of FIG. 2A in which a splitting mechanism is used to split an image propagated or transported by a cable into two parts (e.g., left and right image);

FIG. 6B shows an exemplary splitting mechanism according to one embodiment of the present invention;

FIG. 7A shows a block diagram of using a pair of display glasses (i.e., display device) with a portable device;

FIG. 7B illustrates an internal functional block diagram of an exemplary docking unit that may be used in FIG. 7A or as an independent portable device that may be operated by a wearer to control the display device;

FIG. 8A shows what is called herein an active optical cable that includes two ends and a plurality of fibers coupled between the two ends; and

FIG. 8B and FIG. 8C each show an example of an active optical cable that includes four fibers for transporting four channel signals and three wires for the power and ground and a data bus.

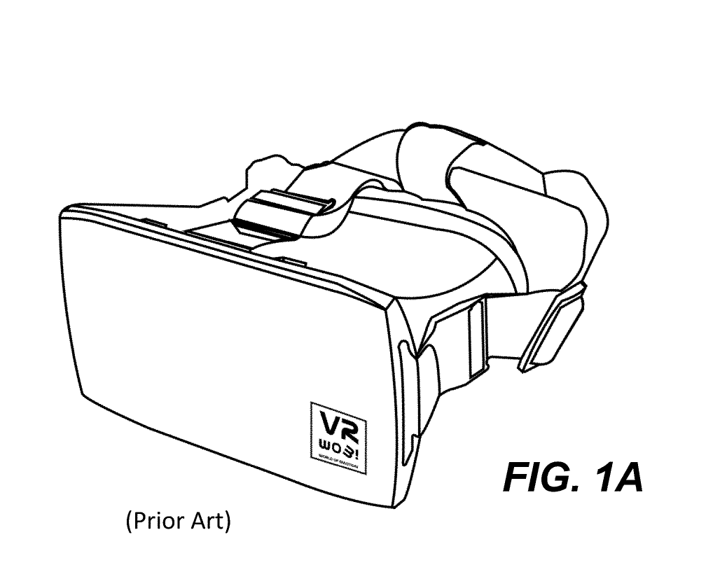

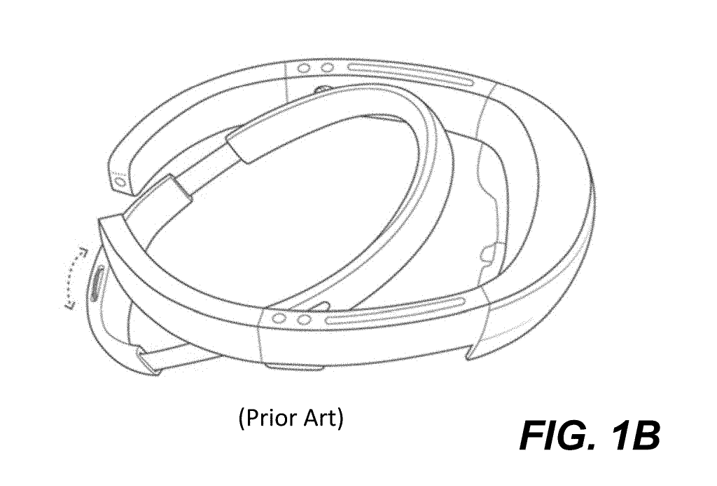

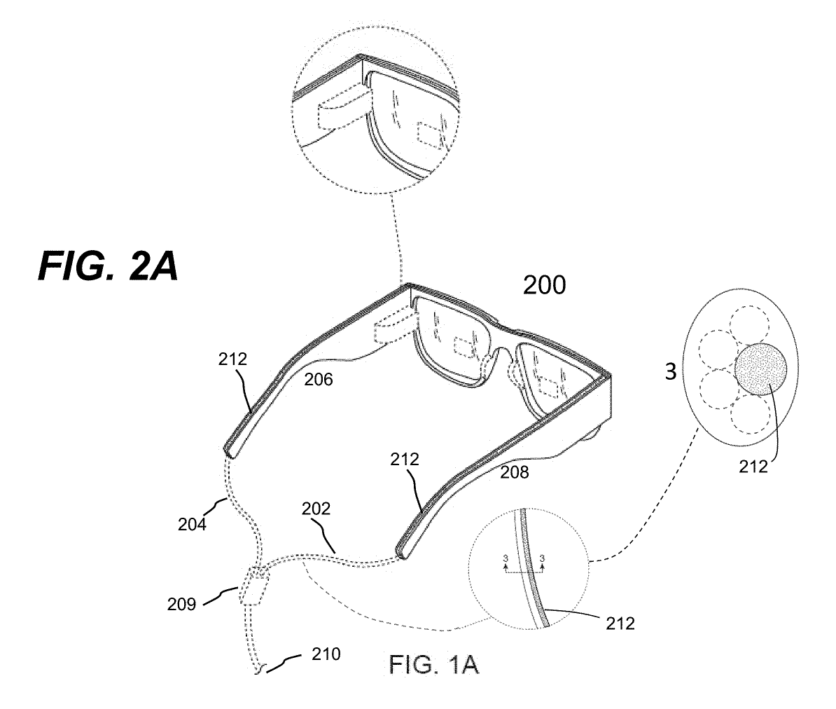

### DETAILED DESCRIPTION OF THE PREFERRED EMBODIMENTS

The detailed description of the invention is presented largely in terms of procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

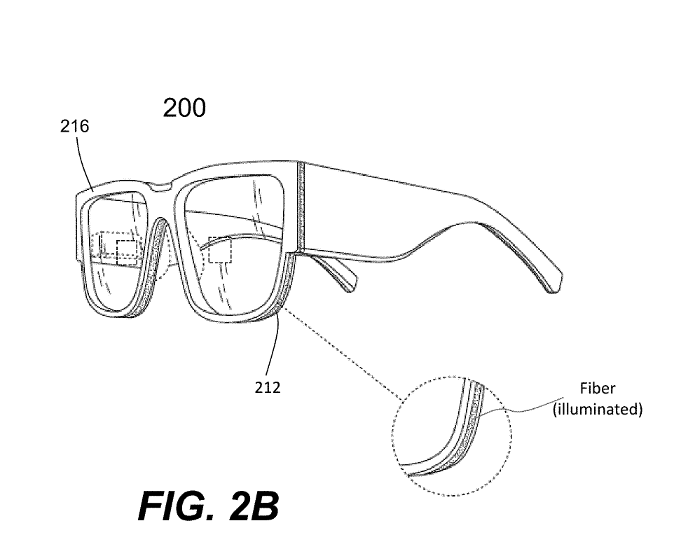

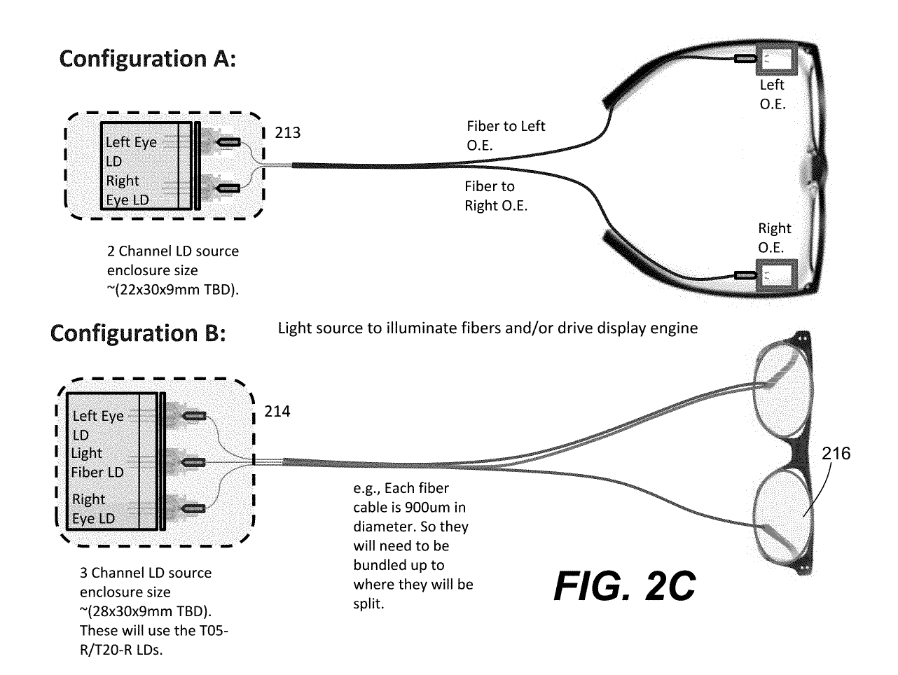

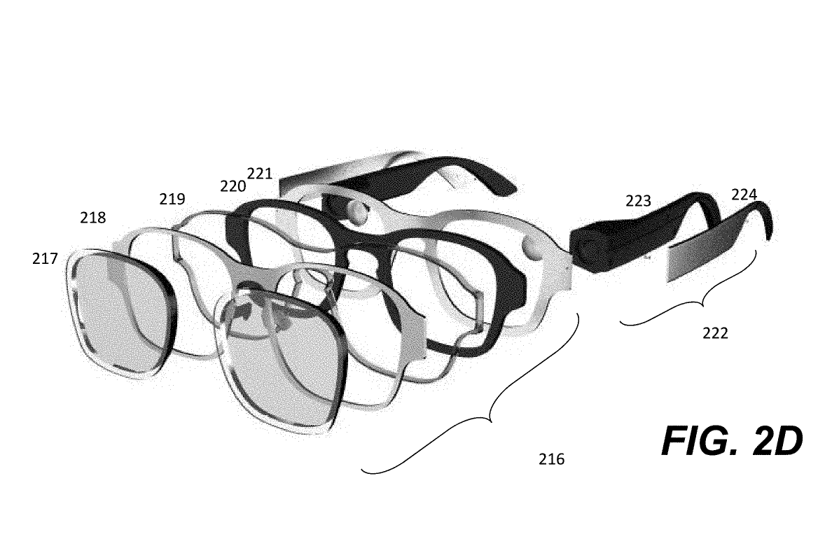

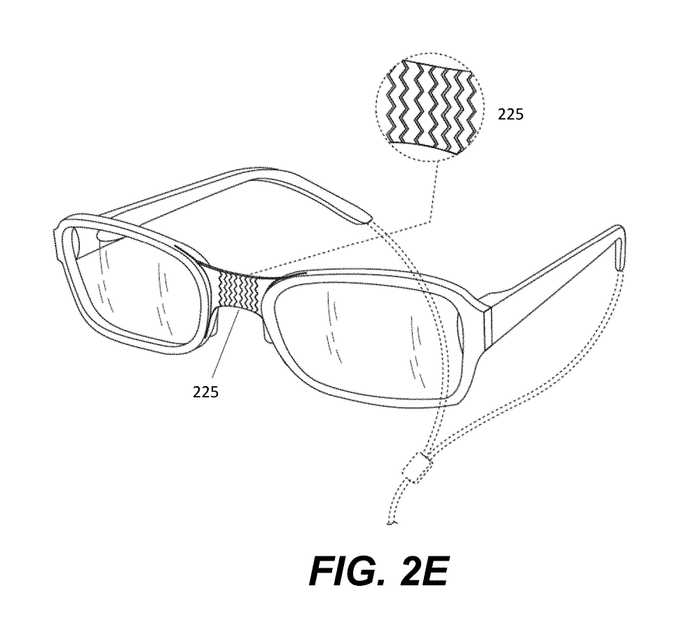

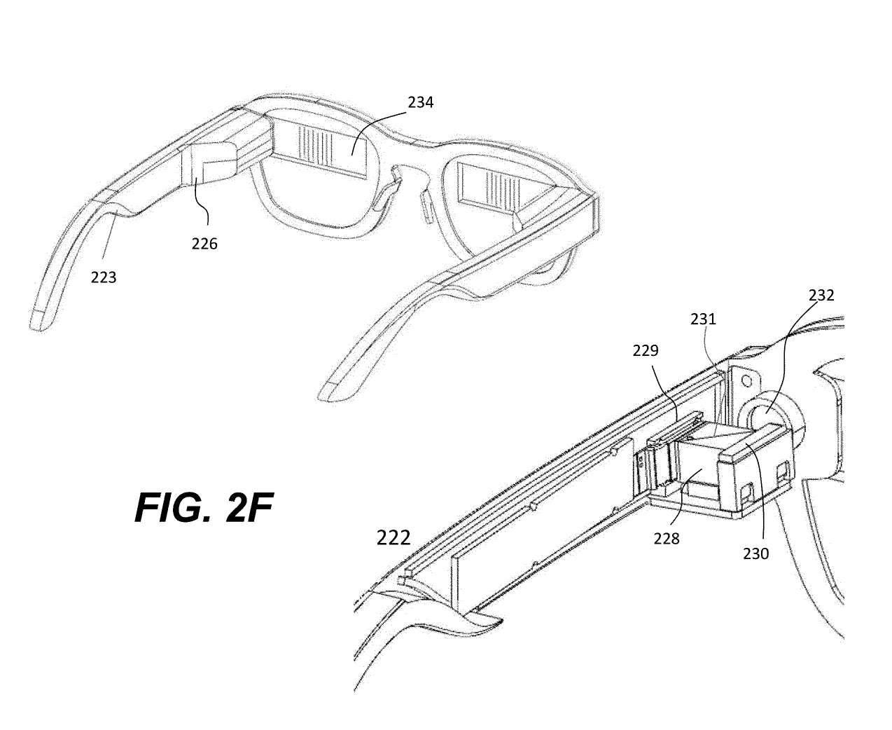

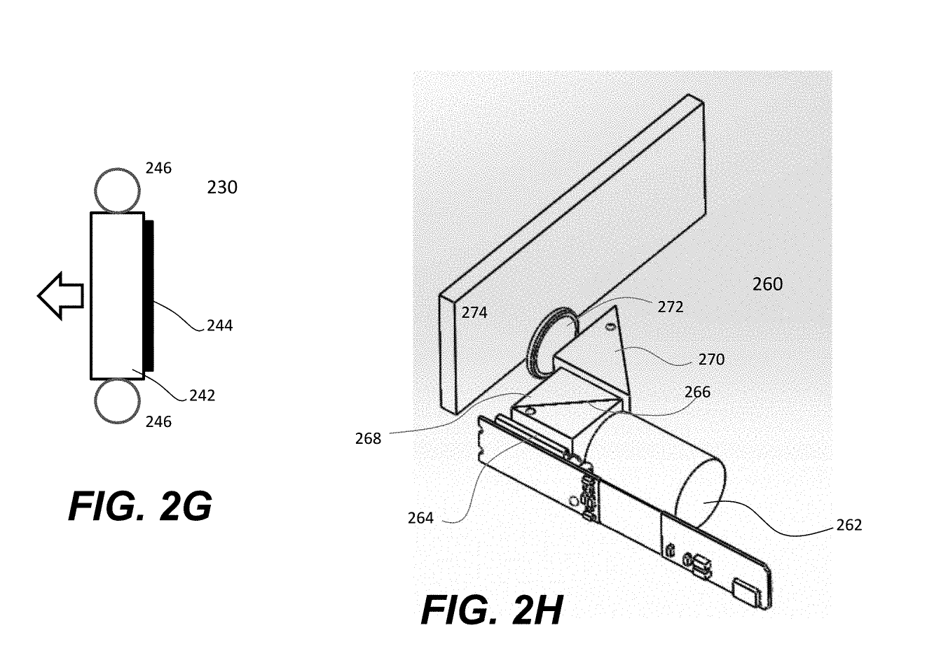

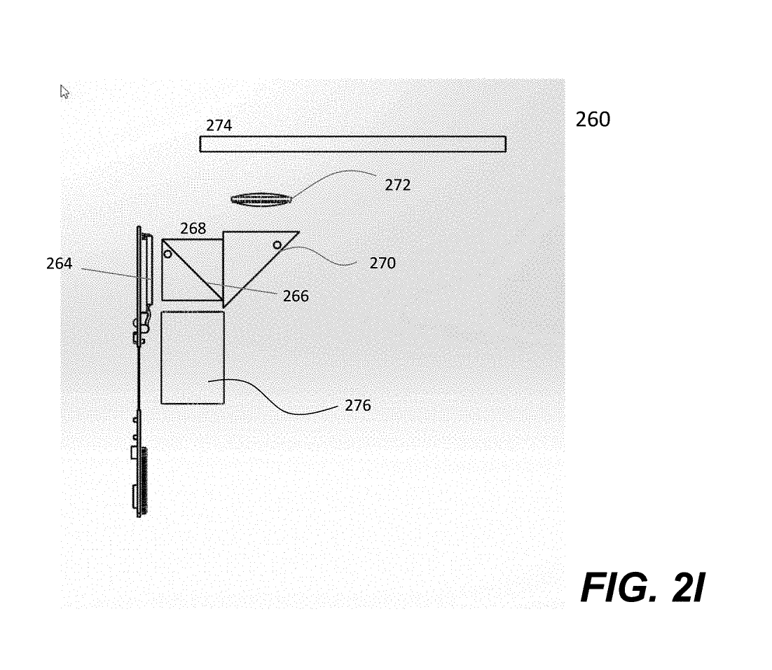

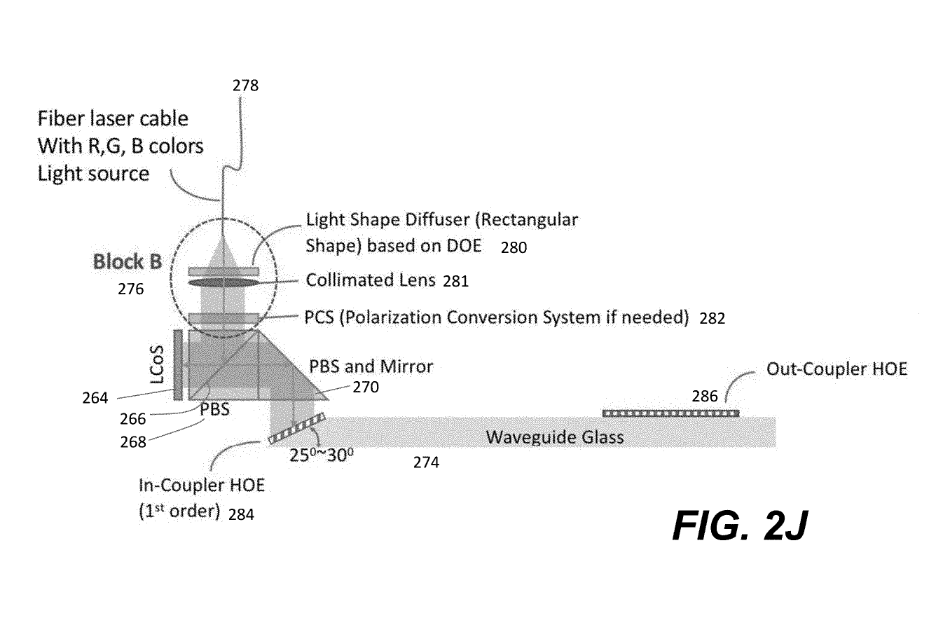

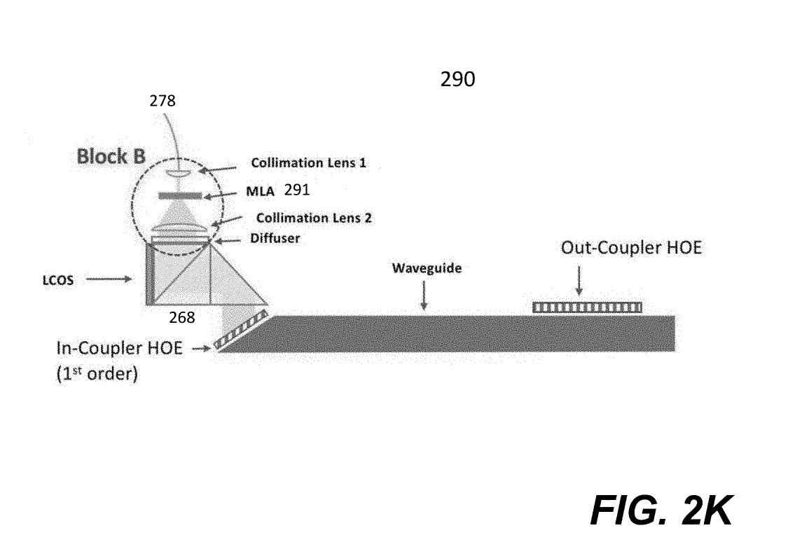

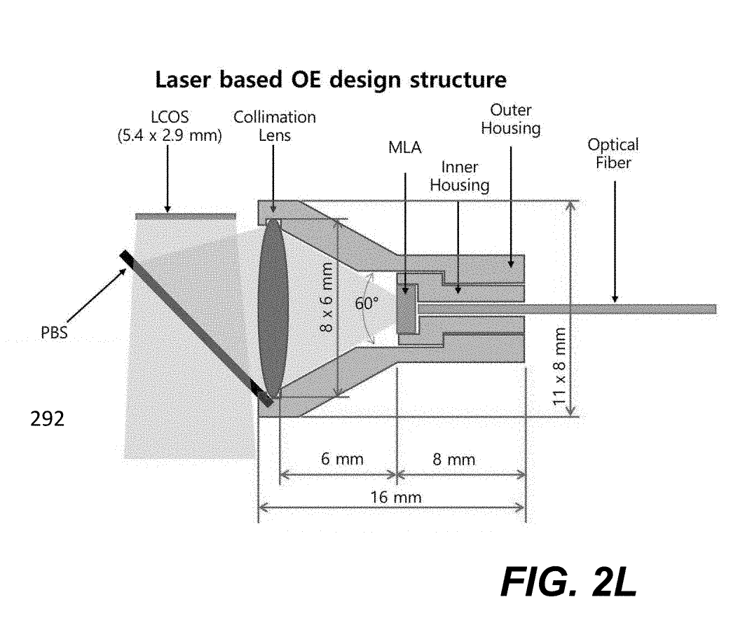

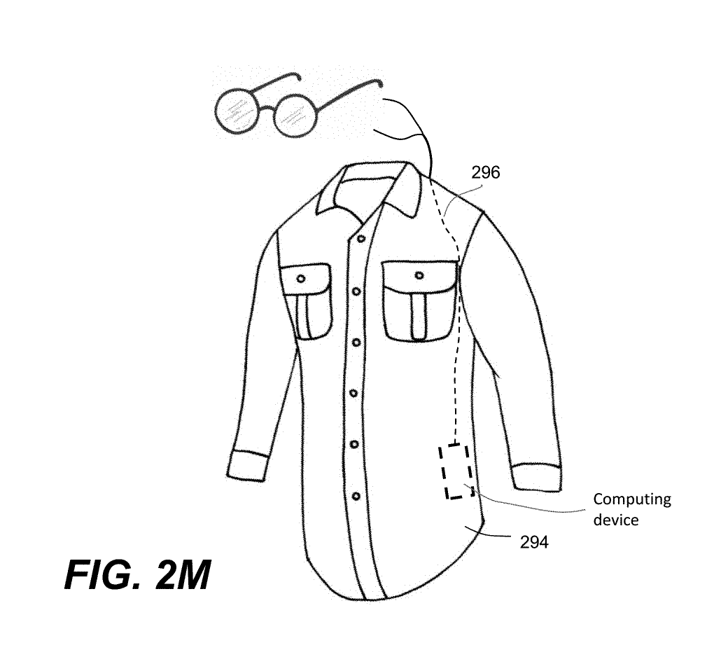

Embodiments of the present invention are discussed herein with reference to FIGS. 2A-8C. However, those skilled in the art will readily appreciate that the detailed description given herein with respect to these figures is for explanatory purposes as the invention extends beyond these limited embodiments.

Referring now to the drawings, in which like numerals refer to like parts throughout the several views. FIG. 2A shows a pair of exemplary glasses 200 that are used for applications of VR/AR according to one embodiment of the present invention. The glasses 200 appear no significant different to a pair of normal glasses but include two flexible cables 202 and 204 that are respectively extended from the temples 206 and 208. According to one embodiment, each pair of the two flexible cables 202 and the temples 206 and 208 are integrated or removably connected at one end thereof and include one or more optical fibers and a minimum number of wires (e.g., 2 copper wires).

Both of flexible cables 202 are coupled at another end thereof to a pendent or enclosure 209 that is further coupled to a portable computing device (not shown) via a cable 210, where the computing device provides an image source (e.g., video and audio). Depending on the implementation, the image source may be an electric image (i.e., in digits) or an optical image (i.e., in light beams of varying intensities). The pendent 209 including necessary circuitry is provided to receive signals from the computing device and fork them to the cables 202 and 204, respectively. Depending on the implementation, the cable 210 and each of the cables 202 and 204 are identical or different slightly in the use of an extra optical fiber to lead illumination to the temples 206 and 208, and/or the lens frame holding up the two lenses.

According to one embodiment, the pendent 209 includes a light source (not shown) to illuminate two optical fibers 212, each enclosed in the cable 202 or 204. As shown in FIG. 2A, these two optical fibers 212 are respectively disposed or embedded in the edges (e.g., the top and/or bottom edges of the temples 206 and 208). FIG. 2B shows that the optical fibers 212 are embedded in the surrounding edges of the lens frame 216 of the glasses 200. When the light source is turned on, the glasses (i.e., the edges thereof) would glow, especially in dark to create a level of fashion or getting attention from others. Depending on the implementation, the light source may or may not be modulated or in synch with the media being displayed or the audio played back in the glasses.

Referring now to FIG. 2C, it shows two exemplary configurations A and B in which a sample structure of the light source may be used to illuminate the optical fibers 212. Configuration A shows that two diodes (e.g., red or visible laser) are used to illuminate the optical fibers 212, one going to the left temple and the other going to the right temple. These two diodes may be in the same or different colors. Configuration B shows that three diodes (e.g., red or visible laser) are used to illuminate the optical fibers 212 and an extra fiber that is specifically embedded in the lens frame 216 of the glasses shown in FIG. 2B. As a result, the fibers on the temples and on the lens frame may be illuminated independently or come in one or more different colors. According to another embodiment, the light source uses only one laser diode, the light coming out from the diode is split into two or three beams via one or two beam splitters (e.g., diffraction optical element (DOE)). It should be noted that the diodes are used in the light source as an example. Those skilled in the art understand that other types of lighting source may also be used as long as they are light in weight and efficient in energy.

FIG. 2D shows an exemplary structure of the lens frame 216 in the glasses according to one embodiment of the present invention. The lens frame 216 is made of several layers of materials to strengthen the structure as well as to embed the fiber 212. In one embodiment, there are five layers as shown in FIG. 2D: layer 217 is shown as a pair of lens, layer 218 is a front frame made of a type of material, layer 219 is an illuminated frame formed mainly by one or more fibers to be illuminated, layer 220 is a middle frame made of a type of material and layer 221 is a rear frame made of a type of material. The fibers used in the illuminated frame 219 may be extended from the fibers 212 (resulting in the same illuminated color as on the temples) or from an independent fiber or fibers illuminated by a separate diode as shown in configuration B of FIG. 2C (resulting in different illuminated color from the temples).

According to one embodiment, the illuminated frame 219 is embedded with a fiber or the fiber is embedded around the edges of the middle frame 220 that is then sandwiched between the front frame 218 and the rear frame 221. An exemplary material of the middle frame 220 is preferably non-opaque, for example, polycarbonate which makes it easy to form the shape of the frame integrated with the fibers. An exemplary material of the front frame 218 and the rear frame 221 is aluminum or magnesium, preferably being opaque. The lens frame 216 of the glasses is formed by stacking or integrating these layers together. However, it should be noted that fewer than these layers 218, 219, 220 and 221 are also possible to form a lens frame. For example, when the illuminated frame 219 is not used, the illuminated frame 219 and/or the middle frame 220 can be omitted, resulting in a lens frame of fewer layers.

FIG. 2D also shows an exemplary structure of the temple 222 of the glasses. The temple 222 includes an inner temple 223 and an outer temple 224, shaped substantially similar and integrated together. The inner temple 223 (e.g., in plastic or polycarbonate) provides a conduit to accommodate wires and fibers and form an enclosure near the lens frame to enclose optical and electronic parts. In one embodiment, the cable 202 (or 204) is coupled to one end of the inner temple 223, the fiber 212 in the cable 202 is parted away from the cable 202 and embedded around the edges of the inner temple 223, namely the upper and bottom of the inner temple 223. When the fiber 212 is illuminated by the diode in FIG. 2C, the temple 222 appears glowing.

FIG. 2E shows a perspective view of an exemplary display glasses according to one embodiment of the present invention. The display glasses use a flexible bridge 225 that can be adjusted to fit an interpupillary distance and lens-to-eye distance if needed. In other words, the bridge 225 may be extended outwards to increase the distance between the respective centers of the two lenses to fit the interpupillary distance of a wearer. When the wearer has a different comfortable level for his own lens-to-eye distance, the two lenses in the glasses may also be adjusted back and forth as the bridge 225 is designed to have the mechanism to be bent slightly back and forth. According to one embodiment, the bridge 225 is implemented with a mechanism similar to a watch band that allows expanded and twisted slightly to fit a need. Those skilled in the art are readily to understand that the frames in FIG. 2D would be modified accordingly when the flexible bridge 225 is required.

FIG. 2F shows a rear perspective of an exemplary display glasses according to one embodiment of the present invention and a corresponding exposed internal structure of the temple 222 shown in FIG. 2D. Also shown is the enclosure 226 to house optical and electronic parts. According to one embodiment, there is an optical cube 228 in the enclosure 226. A microdisplay 229 and a light source 230 are attached to the optical cube 228. The light from the light source 230 goes through the cube 228 and is modulated by a displayed image on the microdisplay 229 to form an optical image. The optical image is reflected from the microdisplay 229 and impinged upon the cube 228. A specially designed film or coating 231 in the cube 228 redirects the optical image to an optical unit 232 that projects the optical image into an optical waveguide 234. As will be further described below, the optical waveguide 234 acts as a medium to propagate the image to an appropriate position therein for a wearer to view the optical image.

According to one embodiment, FIG. 2G shows an implementation of the light source 230 including a light guide 242, a shade 244 and one or more lights 246 (two of which are shown). An example of the lights 246 is one or more LEDs, such as a collection of red, green and blue LEDs or white LEDs, depending on the operation of the microdisplay 229. Illumination from the lights 246 is projected into the guide 242. In one embodiment, the shade 244 is reflective on one side and opaque on the other side. Such a shade 244 is provided to reflect the illumination onto the block 228 of FIG. 2F, besides preventing any of the illumination from going out of the guide 242. In other words, the shade 244 may be made with a film coated on one side being reflective and the other side being opaque.

Referring now to FIG. 2H, it shows an assembly 260 that fits into the enclosure 226 according to another embodiment of the present invention. Instead of using the LEDs as a light source, the assembly 260 uses a laser source 262 in three primary colors (e.g., red, green and blue) that scans the microdisplay 264 via a reflector 266 (e.g., a film or coating in the optical cube 268) to generate a redirected laser beam. As the redirected laser beam scans the microdisplay 264, generating a reflected beam. A reflector 270 is provided to guide the reflected laser beam towards an optical unit 272 (e.g., a collimator), where the optical unit 272 projects the reflected laser beam into an optical waveguide 274. In operation, a laser beam from the laser source 262 is caused to scan the microdisplay 264, the reflected laser beam scans accordingly in the optical waveguide 274 to form a laser-based optical image that can be viewed within the waveguide 274 by a wearer.

FIG. 2I shows an topview 261 of FIG. 2H but uses a different laser source 276 according to one embodiment of the present invention. Instead of producing a laser beam to scan the microdisplay 264, the laser source 276 produces a 2D laser plane. In general, a laser comes in a dot. The laser source 276 includes necessary optical parts to convert a laser dot to a laser plane. FIG. 2J shows one exemplary embodiment of generating a 2D laser plane from a laser dot using a set of optical parts. A laser beam 278 in red, green or green is projected via a lens (not shown) onto a light shaping diffuser or light shape diffuser 280. In one embodiment, the laser beam 278 is provided by a source in the pendent 209, using a similar configuration in FIG. 2C or simply a single laser source (e.g., laser diode) via a splitter.

With proper constraints on the light shape diffuser, a laser dot is converted to a laser plane that is then projected through a collimated lens 281. The collimated laser plane is projected into the cube 268 and reflected to the microdisplay (LCoS) 264 by a transmissive reflector or coating 266 in the cube 268. As used herein, a transmissive reflector means that a reflector or filter reflects a certain colored (wavelength) light while allowing another colored (wavelength) light to pass through. As a media is being displayed on the microdisplay (LCoS) 264, the collimated laser plane is reflected from the microdisplay 264 back to the cube 268 and goes through the transmissive reflector 266 and hits a mirror or reflector 270 that turns the reflected laser beams onto an in-coupler 284. It can be appreciated that the in-coupler 284 is slanted with respect to the incoming collimated laser beams. Once entering the waveguide 274, the reflected laser beams are propagated within the waveguide 274 to another end thereof, where the propagated laser beams are coupled out by an out-coupler 286. As the successive rotation of three colored lasers, three propagated laser beams in three different colors are combined visually to reproduce a full color image or video.

FIG. 2K shows another embodiment 290 of using a laser plane. In comparison with the embodiment shown in FIG. 2J, the embodiment in FIG. 2K uses what is called micro lens array (MLA) 291. As the name suggests, an MLA 291 includes an array of microstructures that cause a laser dot into a laser plane. The detail of various microstructures, available on the Internet, is not further described herein to avoid obscuring the aspects of the present invention.

As shown in FIG. 2K, a laser dot 278 is projected onto a first collimation lens. The collimated laser dot is now projected onto the MLA 291 that turns the laser dot into a laser plane that is further collimated before it enters the cube 268. FIG. 2L shows a cross section of one implementation 292 according to the embodiment shown in FIG. 2K.

There are different types of microdisplays. The detailed description of how each of these microdisplays works with a light source is being omitted to avoid obscuring the important aspects of the present invention. Those skilled in the art can easily understand the operation of a chosen microdisplay along with the configuration of corresponding light source. The table below summarizes some of the microdisplays that may be used to facilitate the generation of an optical image that can be projected into an optical waveguide in front of an eye.

| No. | Microdisplay types | Features | Notes |
|---|---|---|---|
| 1 | LCoS (LCD and OLED) | Full color image | A single |
| | | displayed on a silicon | image |
| 2 | LCoS + LED (RGB | A single color image | Three |
| | sequentially) | displayed at a time | images |
| | LCoS + laser (visible, RGB | | |
| | sequentially) | | |
| | LCoS + laser (non-visible) | | |
| 3 | SLM + laser (RGB | A single optical color | Three optical |
| | sequentially) | image | images |
| 4 | SLM + laser (non-visible) | A single non-visible | Need |
| | | color image | conversion |

LCoS = Liquid crystal on silicon;
LCD = Liquid crystal display;
OLED = Organic light-emitting diode;
RGB = Red, Green and Blue; and
SLM = Spatial light modulation.

In the first case shown above in the table, a full color image is actually displayed on a silicon device (i.e., microdisplay). The full color image can be picked up by an optical cube with or without a focal lens or a set of lenses and then is projected right into an optical waveguide. The image is then transported within the waveguide to a predefined location for viewing by a wearer of the display glasses.

In the second case shown above in the table, an LCoS is used with different light sources. In particular, there are at least three colored light sources (e.g., red, green and blue) used sequentially. In other words, a single color image is generated per one light source. A full color image can be reproduced when all three different single color images are combined. The third and fourth cases shown above in the table are similar to the first and second cases in operations.

As described above, the cable 210 is coupled to a computing device providing data and controls. In general, the computing device is worn by a wearer of the display glasses, for example, on a waist belt or in a pocket. It is sometimes troublesome to have a cable hanging around which significantly limits the motion of the wearer. FIG. 2M shows an article of clothing (e.g., a shirt 294) in which a cable 296 is enclosed within the material of the shirt 294 or attached thereto. The shirt 294 is an example of fabric material or multi-layers. Such a relatively thin cable can be embedded into the multi-layers or stitches thereto. When a user wears such a shirt made or designed in accordance with one of the embodiment, the cable itself has less weight while the user can have more freedom to move around.

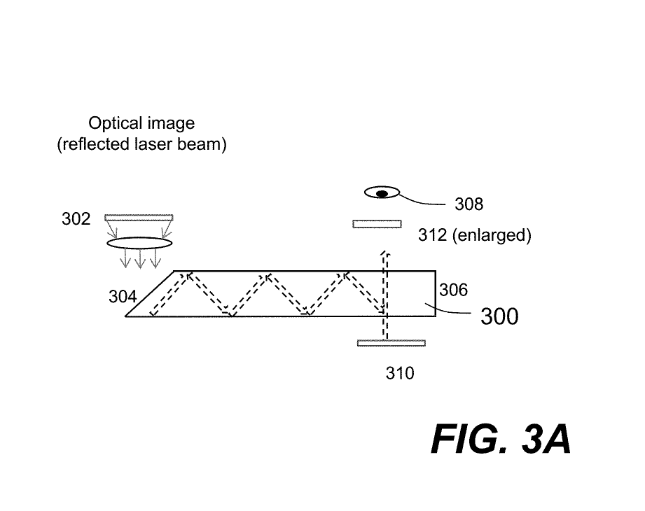

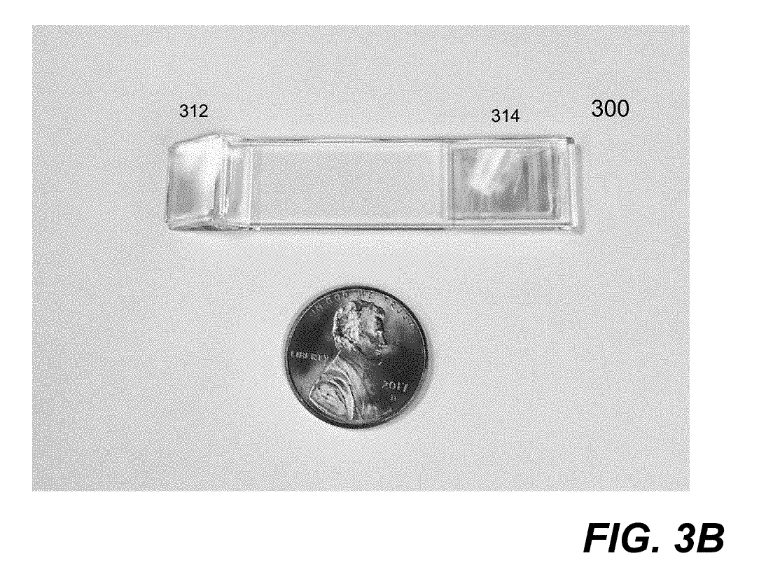

Referring now to FIG. 3A, it shows that an optical waveguide 300 is used to transport an optical image 302 from one end 304 of the waveguide 300 to another end 306, wherein the waveguide 300 may be stacked with or between one or more pieces of glass or lenses (not shown) or coated with one or more films to from a suitable lens for a pair of glasses for the applications of displaying images from a computing device. It is known to those skilled in that art that an optical waveguide is a spatially inhomogeneous structure for guiding light, i.e. for restricting the spatial region in which light can propagate, where a waveguide contains a region of increased refractive index, compared with the surrounding medium (often called cladding).

The waveguide 300 is transparent and shaped appropriately at the end of 304 to allow the image 302 to be projected in and propagated along the waveguide 300 to the end 306. According to one embodiment, the end 304 of the waveguide 300 is slanted to allow the optical image to be projected right onto the slanted surface. More specifically, the optical image is focused and projected onto the slanted surface 304 at angle not equal to 90 degrees (e.g., at 45 degrees). Optically, the slanted surface facilitates efficient entry and propagation of the optical image within the waveguide, assuming the refractive index of the material for the waveguide is higher than that of the surrounding medium.

Once the image is propagated to the end 306, a user 308 can see through the waveguide 300 so as to see the propagated image 310. According to one embodiment, one or more films 312 are disposed upon the waveguide 300 to amplify the propagated image 310 so that the eye 308 can see a significantly amplified image 312. One example of such films is what is called metalenses, essentially an array of thin titanium dioxide nanofins on a glass substrate.

FIG. 3B shows an implementation of the optical waveguide 300, the size of which is being compared with a cent. The optical waveguide 300 includes an optical coupler 312 provided to couple an optical image into the waveguide 300. As also shown in FIG. 3A, one end of the waveguide 300 is made slanted to facilitate the projection of the image into the waveguide 300 via the optical coupler 312. On the other end, there is another coupler 314 to couple the image out. In one embodiment, the couplers 312 and 314 are holographic optical elements (HOE). To differentiate between the couplers 312 and 314, the coupler 312 is referred to as in-coupler while the coupler 314 is referred to as out-coupler. The details of how the waveguide is made or operates are omitted herein to avoid obscuring the aspects of the present invention.

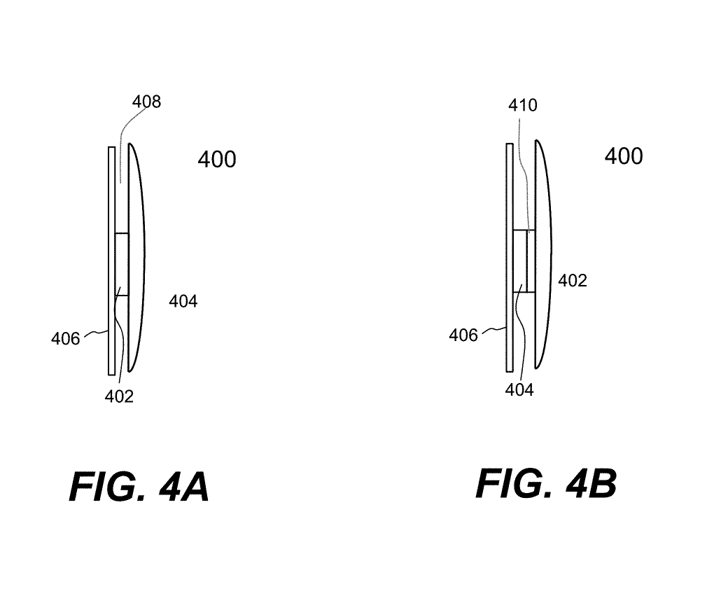

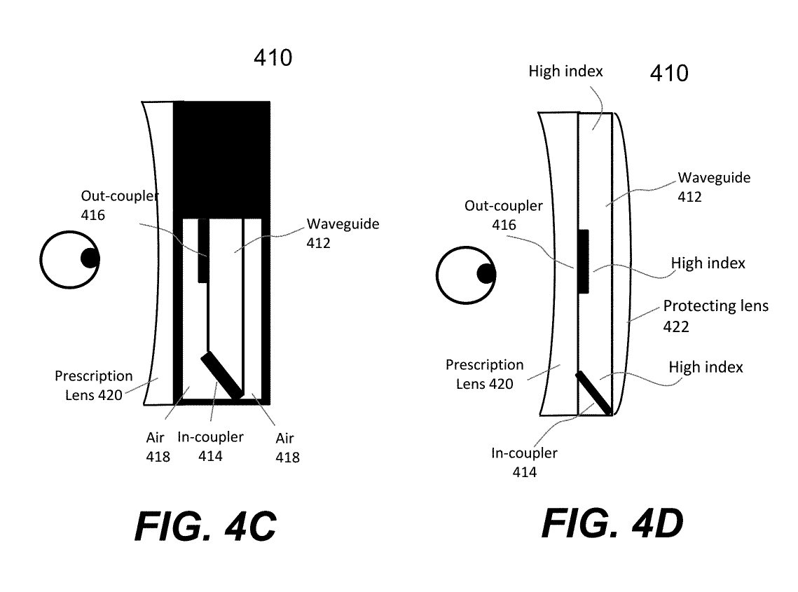

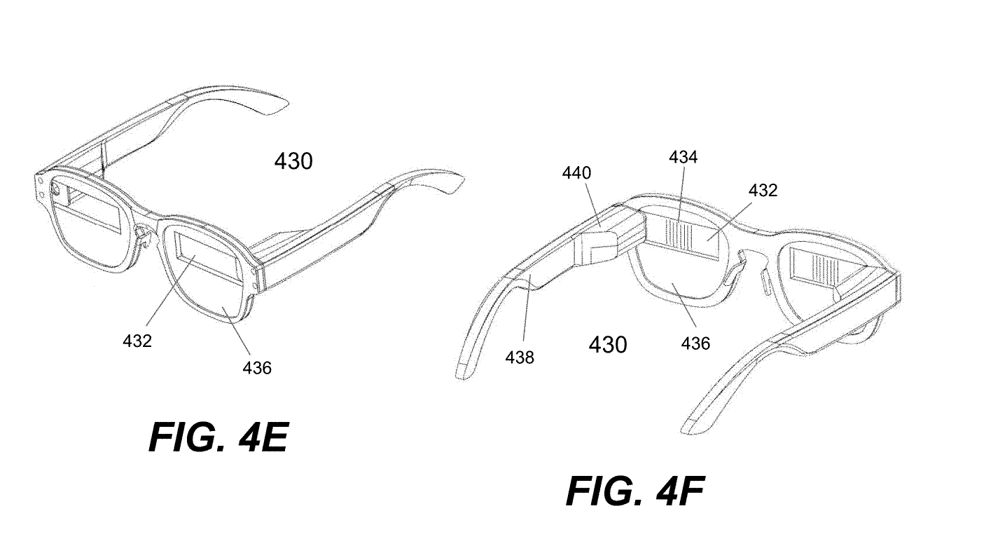

Referring now to FIG. 4A, it shows an embodiment of an integrated lens 400 used in the display glasses of FIG. 2A, according to one embodiment of the present invention. As described above, an optical waveguide is used to propagate an optical image from one end thereof to another end thereof. The integrated lens 400 shows how such a waveguide 402 is integrated with a lens that may be a plain protecting lens or a prescription lens (e.g., for near or far vision). As shown in FIG. 4A, the integrated lens 400 being see-through includes a lens 404 and a protecting sheet (clear lens) 406, where the waveguide 402 is sandwiched between the lens 404 and the protecting sheet 406. As will be further explained below, the refraction index of the material for the waveguide is larger than that for the lenses 404 and 406.

In general, the waveguide 402 is only a portion of the integrated lens in size, the gap 408 created by the waveguide 402 between the lens 404 and the protecting sheet 406 is filled by a type of clear material so that the integration of the waveguide 402, the lens 404 and the protecting sheet 406 forms the integrated lens 400. FIG. 4B shows another embodiment of the integrated lens 400 in which an amplifying lens 410 is integrated with the waveguide 402 so that a displayed image in the waveguide 402 is amplified when seeing through the integrated lens. At the same time, a wearer may also use the display glasses to perform regular activities (e.g., driving or reading) when the display glasses are not turned on to display any media.

FIG. 4C shows an implementation of an integrated lens 410 that may be used in the display glasses of FIG. 2A, according to one embodiment of the present invention. As described above, an optical waveguide 412 is used to propagate an optical image projected via an in-coupler 414 to another end where an out-coupler 416 allows an eye to view the optical image. To ensure the optical image being propagated by total internal reflections within the waveguide 412, a gap space 418 filled with air or a type of gas (e.g., argon or krypton) is formed around the waveguide 412. In optics, it is known that a region of increased refractive index, compared with the surrounding medium, allows light to propagate within the region. In one embodiment, the materials used to make the couplers 414 and 416, the waveguide 412, and the prescription lens 420 are substantially similar, for example, polycarbonate. As a result, the refractive index of a transparent material surrounding the waveguide 412 has to be far less than that of the polycarbonate. In one embodiment, the refractive index of the material (e.g., polycarbonate) for the waveguide 412 is 1.45 while the air is 1.0003 (argon is in the similar range). To fit the need for those who may be impaired in vision, a prescription lens 420 is added to form the integrated lens 410.

FIG. 4D shows another implementation of an integrated lens 410 in which the refractive index of the waveguide 412 and the couplers 414 and 416 is substantially higher than that of the prescription lens 420 and/or a protecting sheet or lens 422. As the refractive index of the surrounding material (i.e., the prescription lens 420 and the protecting lens 422) is lower than that of the waveguide 412, the optical image can travel within the waveguide 412 by total internal reflections.

For completeness, FIG. 4E and FIG. 4F show a front perspective of an exemplary display glasses 430 per one embodiment and a corresponding rear perspective of the display glasses 430. The waveguide 432 with the out-coupler 434 is highlighted for illustration purpose in the integrated lens 436. The temple 438 is expanded outwards at one end to include a pocket or an exposure 440. Depending on the implementation, the shape and/or size of the exposure 440 may be designed differently to minimize the impact thereof on the wearer.

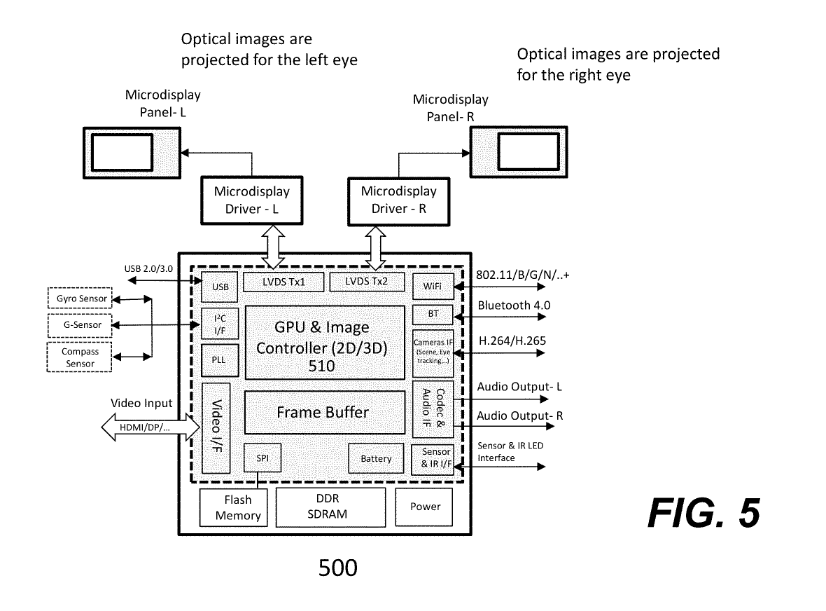

Referring now to FIG. 5, it shows an exemplary functional block diagram 500 that may be used in a separate case or enclosure to produce content related to virtual reality and augmented reality for display on the exemplary glasses of FIG. 2A. As shown in FIG. 5, there are two microdisplays 502 and 504 provided to supply content to both of lenses in the glasses of FIG. 2A, essentially a left image goes to the left integrated lens and a right image goes to the right integrated lens. An example of the content is 2D or 3D images and video, or hologram. Each of the microdisplays 502 and 504 is driven by a corresponding driver 506 or 508.

The entire circuit 500 is controlled and driven by a controller 510 that is programmed to generate the content. According to one embodiment, the circuit 500 is designed to communicate with the Internet (not shown), receive the content from other devices. In particular, the circuit 500 includes an interface to receive a sensing signal from a remote sensor (e.g., mounted on the display glasses) via a wireless means (e.g., RF or Bluetooth). The controller 510 is programmed to analyze the sensing signal and provides a feedback signal to control certain operations of the glasses, such as a projection mechanism that includes a focal mechanism auto-focusing and projecting the optical image into the waveguide. In addition, the audio is provided to synchronize with the content, and may be transmitted to earphones (not shown) wirelessly.

FIG. 5 shows an exemplary circuit 500 to produce the content for display in a pair of glasses contemplated in one embodiment of the present invention. The circuit 500 shows that there are two microdisplays 502 and 504 used to provide two respective images or video streams to the two integrated lenses of the glasses in FIG. 2A. According to one embodiment, only one microdisplay may be used to drive the two lenses of the glasses in FIG. 2A. Such a circuit is not provided herein as those skilled in the art know how the circuit can be designed or how to modify the circuit 500 of FIG. 5.

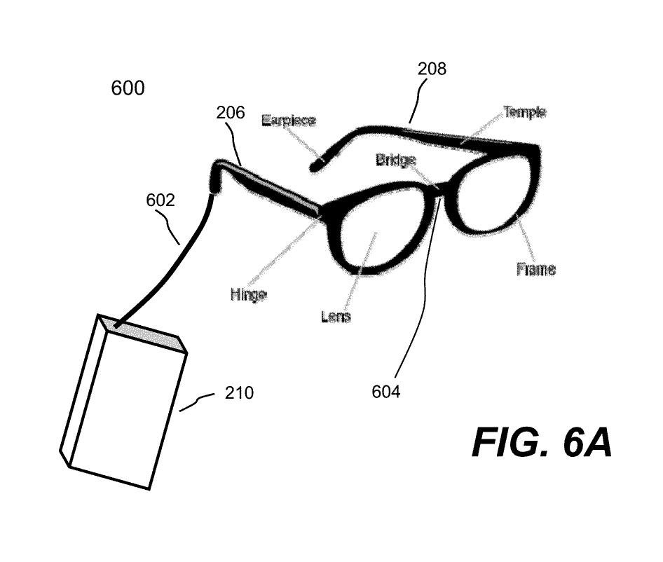

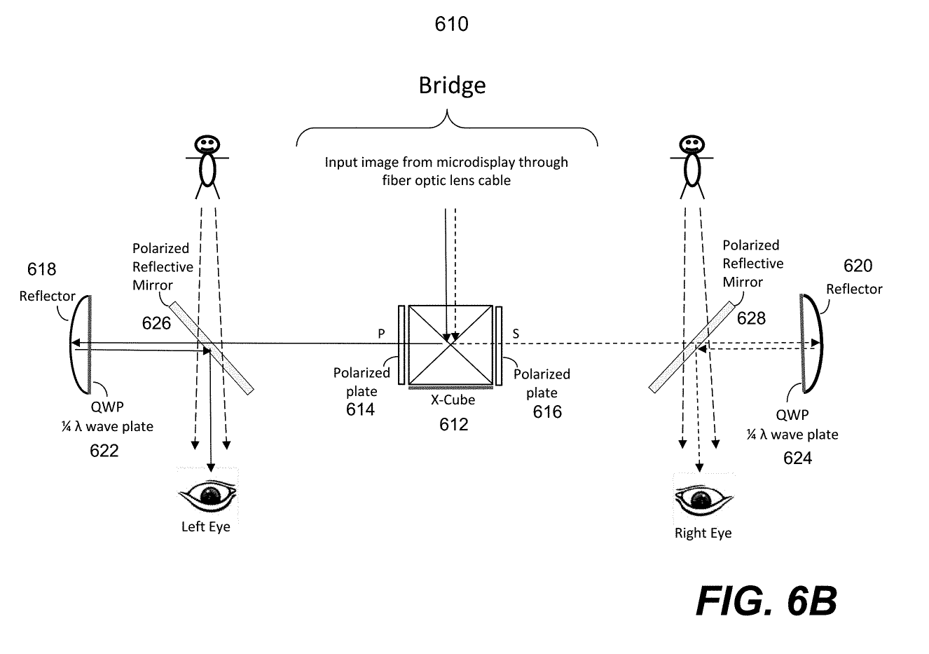

Given one video stream or one image, the advantage is that there is only one optical cable needed to transport the image. FIG. 6A shows a modified version 600 of FIG. 2A to show that one cable 602 is used to couple the enclosure 210 to the glasses 208. Instead of using two cables to drive two microdisplays as shown in FIG. 2A, a single cable is used to drive one microdisplay. The cable may go through either one of the temples of the glasses and perhaps go further to the lens frame. A splitting mechanism disposed near or right on the bridge of the glasses is used to split an optical image into two versions, one for the left lens and the other for the right lens. These two images are then respectively projected into the prisms or waveguides that are used in the two lenses.

To split the image, the glasses 600 are designed to include a splitting mechanism 604 that is preferably disposed near or at the bridge thereof. FIG. 6B shows an exemplary splitting mechanism 610 according to one embodiment of the present invention. A cube 612, also called X-cube beam splitter used to split incident light into two separate components, is provided to receive the image from a microdisplay via the cable 602. In other words, the image is projected onto one side of the X-cube 612. The X-cube 612 is internally coated with certain reflecting materials to split the incident image into two parts, one goes to the left and the other goes to the right as shown in FIG. 6B. A split image goes through a polarized plate 614 or 616 to hit a reflector 618 or 620 that reflects the image back to the polarized reflective mirror 626 or 628. The two polarized plates 614 and 616 are polarized differently (e.g., in horizontally and vertically or circular left and right) corresponding to the images sequentially generated either for left eye or right eye. Coated with certain reflective material, the polarized reflective mirror 626 or 628 reflects the image to the corresponding eye. Depending on the implementation, the reflected image from the polarized reflective mirror 626 or 628 may be impinged upon one edge of the prism 262 of FIG. 2F or the waveguide 400 of FIG. 4. Optionally, two wave plates 622 and 624 are respectively disposed before the reflectors 618 and 620.

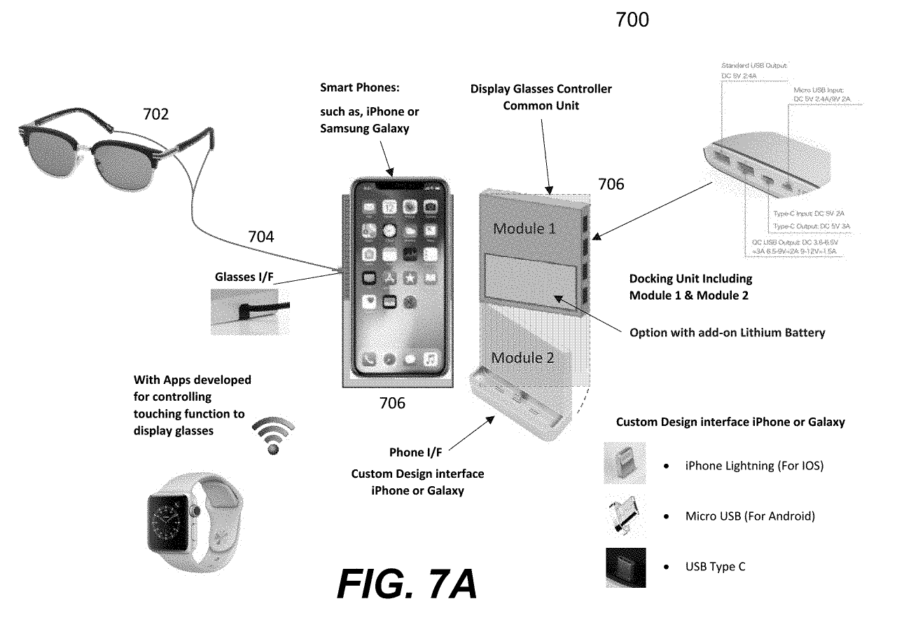

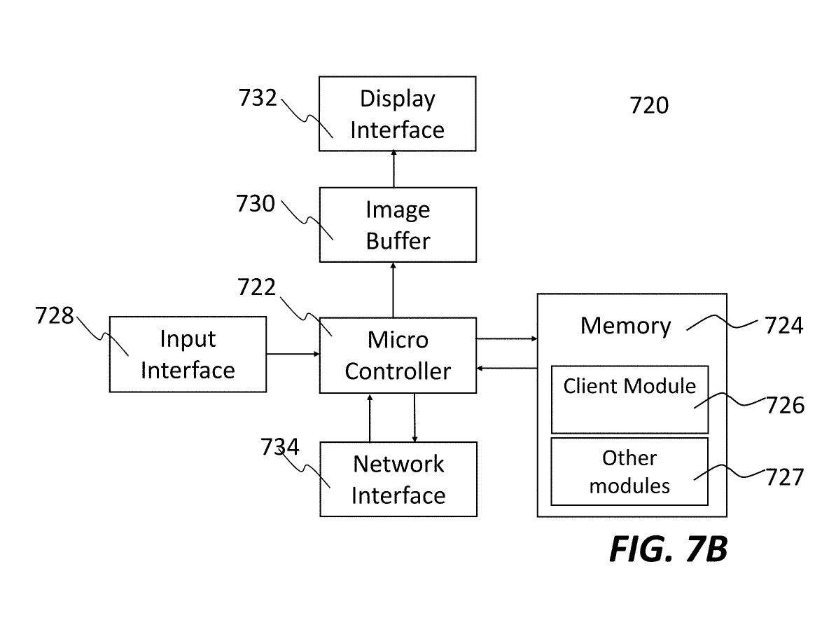

Referring now to FIG. 7A, it shows a block diagram 700 of using a pair of display glasses (i.e., display device) 702 with a portable. According to one embodiment, the portable device is implemented as a docking unit to receive a smartphone (e.g., iPhone). The glasses 200 of FIG. 2A may be used as the display device 702. A cable 704 is used to couple the glasses 702 to the docking unit 706 provided to receive a smartphone. The docking unit 706 allows a user (i.e., a wearer of the display device 702) to control the display device 702, for example, to select a media for display, to interact with a display, to activate or deactivate an application (e.g., email, browser and mobile payment).

According to one embodiment, the docking unit 706 includes a set of batteries that may be charged via a power cord and used to charge the smartphone when there is a need. One of the advantages, benefits and objectives in the embodiment of providing a docking unit is to use many functions already in the smartphone. For example, there is no need to implement a network interface in the docking unit because the smartphone has the interface already. In operation, a user can control the smartphone to obtain what is intended for, the content of which can be readily displayed or reproduced on the display device via the cable 704 coupling the docking unit 706 to the display device 702.

As shown in FIG. 7A, the docking unit 706 includes two parts, either one or both may be used in one implementation. The first part includes a receiving unit to receive a smartphone and may or may not have a battery pack that can be recharged and charge the smartphone when there is one. The second part includes various interfaces to communicate with the smartphone to receive data and instructions therefrom for the display device 702 to display images/videos for the wearer to view on the display glasses. One of the important features, benefits and advantages in the present invention is the use of an active optical cable to couple a portable device to the display device 702. In general, the portable device is worn by the wearer (e.g., attached to a belt or pocket). In one embodiment, the clothing 270 of FIG. 2I may be used to conceal the cable and provide more freedom for the wearer to move around.

Referring now to FIG. 7B, it illustrates an internal functional block diagram 720 of an exemplary docking unit that may be used in FIG. 7A or as an independent portable device that may be operated by a wearer to control the display device 702. The device, as shown in FIG. 7B, includes a microprocessor or microcontroller 722, a memory space 724 in which there is an application module 726, an input interface 728, an image buffer 730 to drive a display device via a display interface 732 and a network interface 734. The application module 726 is a software version representing one embodiment of the present invention, and downloadable over a network from a library (e.g., Apple Store) or a designated server. One exemplary function provided by the application module 726 is to allow a user (or a wearer of the display device) to enable certain interactions with a display by predefined movements of an eye being sensed by the sensor 266 of FIG. 2F.

The input interface 728 includes one or more input mechanisms. A user may use an input mechanism to interact with the display device by entering a command to the microcontroller 722. Examples of the input mechanisms include a microphone or mic to receive an audio command and a keyboard (e.g., a displayed soft keyboard) or a touch screen to receive a command. Another example of an input mechanism is a camera provided to capture a photo or video, where the data for the photo or video is stored in the device for immediate or subsequent use with the application module 726. The image buffer 730, coupled to the microcontroller 722, is provided to buffer image/video data used to generate the optical image/videos for display on the display device. The display interface 732 is provided to drive the active optical cable and feeds the data from the image buffer 730 thereto. In one embodiment, the display interface 732 is caused to encode certain instructions received on the input interface 728 and send them along the active optical cable. The network interface 734 is provided to allow the device 720 to communicate with other devices via a designated medium (e.g., a data network). It can be appreciated by those skilled in the art that certain functions or blocks shown in FIG. 7B are readily provided in a smartphone and are not needed to be implemented when such a smartphone is used in a docking unit.

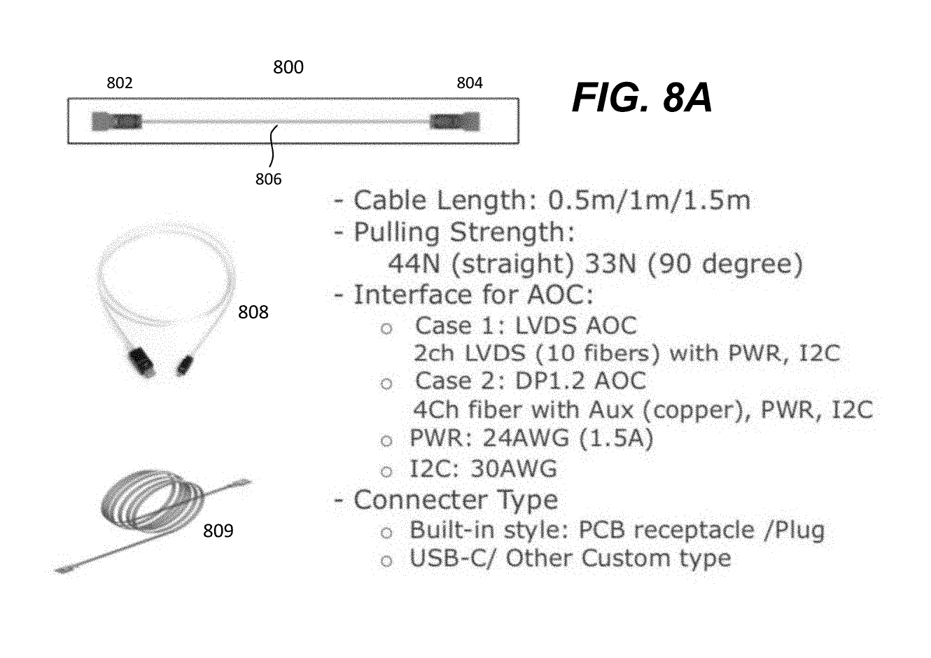

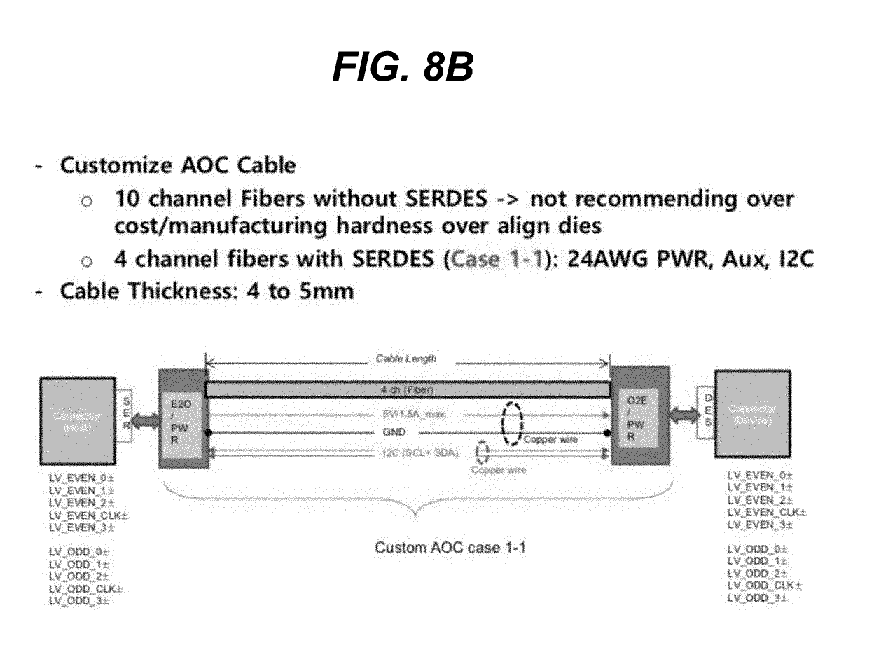

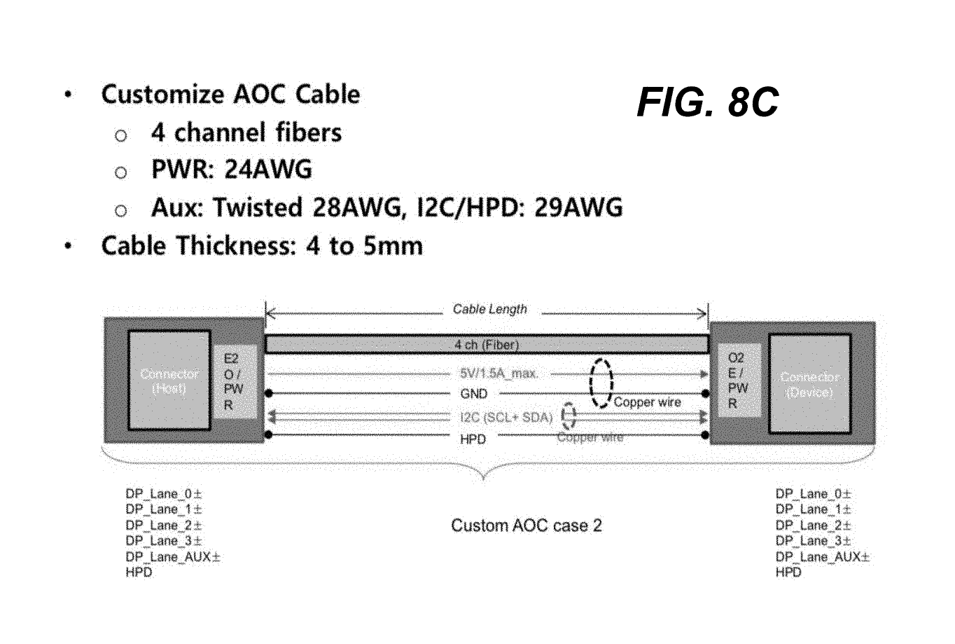

FIG. 8A shows an example of the cable 202 or 210, it is what is called herein an active optical cable 800 that includes two ends 802 and 804 and at least one fiber 806 coupled between the two ends 802 and 804. In addition, there are at least two wires (not visible) in FIG. 8A embedded with the fiber 806, one for power and the other for ground. These two wires are essentially to supply the power from one end to another end. Depending on how or how many signals need to go through the cable 800, the number of the fibers 806 may vary or constant. The two ends 802 and 804 may be implemented as pluggable (e.g., USB-C type) depending on an actual need. Each of the two ends 802 and 804 includes a converter (e.g., a photodiode) to convert an electronic signal to a light or convert a light to an electronic signal. Each of the two ends 802 and 804 further includes necessary integrated circuits to perform encoding or decoding functions if needed, namely a data set or electronic signal when received is encoded and presented in a colored light or the colored light when received is decoded to recover the electronic signal. The details of the end 802 or 804 are not to be further provided herein to obscure other aspects of the present invention. It is assumed that the cable 800 is used to transport a set of signals from the end 802 to the end 804. When the end 802 receives the signals, the converter in the end 802 converts the signals to a light beam including a set of optical signals, where each of the optical signal is encoded per one of the signals. Alternatively, a set of beams is produced by the converter, each beam corresponds to one of the signals. A light beam is then transported within a fiber from the first end 802 to the second end 804. Once reaching the second end 804, a converter in the second end 804 converts the light beam back into one or more electronic signals. It can be appreciated by those skilled in the art that the cable 800 is much lighter than a wire-based cable that would be otherwise used to carry these signals. It can also be readily understood that the active optical cable 800 needs one or more optical fibers to transmit data, control signals or various instructions needed to present appropriate images/videos to a viewer.

FIG. 8A lists specifications such a cable 808 may be implemented based upon. The number of fibers may be individually specified depending on the implementation. In one example, image data in red, green and blue is respectively transported in three different fibers while the control signals are transported in one fiber, thus making a 4-channel fibers configuration for the active optical cable. FIG. 8A also shows the flexibility of such a fiber-based cable that may be folded or extended without loss of the signals. FIG. 8B and FIG. 8C each show an example of the cable 800 that includes 4 fibers for transporting image data and control signals and three wires for the power, ground and a I2C data bus, but with different interfaces (LVDS vs. DisplayPort). As the power consumption is small in this type of application, the wire for the power or the ground can be made very thin to reduce the weight of the cable 800.

The present invention has been described in sufficient detail with a certain degree of particularity. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the forgoing description of embodiments.

We claim:

1. A display engine for media display in a wearable display device, the display engine comprising:
a laser source producing a laser dot in one of three primary colors;
a lens impinged upon with the laser dot;
an optical unit, wherein the laser dot is projected into the optical unit, the optical then produces a laser plane;
an optical cube, formed by two triangular prisms, including a transmissive reflector disposed between two sloping rectangular sides of the triangular prisms;
a collimation lens provided to collimate the laser plane and project the collimated laser plane into the optical cube, where the collimated laser plane is reflected by the transmissive reflector to a microdisplay, reflected laser beams transmit through the transmissive reflector and eventually are projected in a waveguide.

2. The display engine as recited in claim 1, wherein the optical unit includes one or more collimated lens converting the laser dot to the laser plane.

3. The display engine as recited in claim 2, wherein the optical unit further includes a polarization conversion system.

4. The display engine as recited in claim 1, wherein the optical unit includes a micro lens array converting the laser dot to the laser plane the lens through a [symbol] .

5. The display engine as recited in claim 4, wherein the optical unit further includes a collimation lens.

6. The display engine as recited in claim 1, further comprising a fiber providing the laser dot.

7. The display engine as recited in claim 6, further comprising a mirror to reflect the reflected laser beams from the cube to the waveguide via a coupler.

8. The display engine as recited in claim 7, wherein the fiber, the lens, the optical unit;
an optical cube, and the mirror are packaged in an enclosure as part of to a temple.

9. A method for a display engine to operate for media display in a wearable display device, the method comprising:
receiving a laser dot in one of three primary colors;
impinging the laser dot upon a lens;
converting the laser dot laser into a laser plane via an optical unit;
projecting the laser plane onto an optical cube formed by two triangular prisms and including a transmissive reflector disposed between two sloping rectangular sides of the triangular prisms;
collimating the laser plane via a collimation lens; and
projecting the collimated laser plane into the optical cube, where the collimated laser plane is reflected by the transmissive reflector to a microdisplay, reflected laser beams transmit through the transmissive reflector and eventually are projected in a waveguide.

10. The method as recited in claim 9, wherein the optical unit includes one or more collimated lens converting the laser dot to the laser plane.

11. The method as recited in claim 10, wherein the optical unit further includes a polarization conversion system.

12. The method as recited in claim 9, wherein the optical unit includes a micro lens array converting the laser dot to the laser plane the lens through a [symbol] .

13. The method as recited in claim 12, wherein the optical unit further includes a collimation lens.

14. The method as recited in claim 9, wherein the laser dot is received via a fiber.

15. The method as recited in claim 14 comprising: packaging the fiber, the lens, the optical unit, and the optical cube, in an enclosure as part of to a temple.
